(19) United States
(12) Patent Application Publication
(10) Pub. No.: US 2026/0031265 A1
(43) Pub. Date: Jan. 29, 2026

(54) COIL DEVICE

(71) Applicant: TDK CORPORATION, Tokyo (JP)

(72) Inventors: Toshiyuki HORIKAWA, Tokyo (JP); Masayuki NAGATA, Tokyo (JP); Masaaki IWAKURA, Tokyo (JP)

(73) Assignee: TDK CORPORATION, Tokyo (JP)

(21) Appl. No.: 19/274,891

(22) Filed: Jul. 21, 2025

(30) Foreign Application Priority Data
Jul. 25, 2024 (JP) 2024-119664

(51) Int. Cl. H01F 27/26; H01F 27/02; H01F 27/28

(52) U.S. Cl. CPC H01F 27/263; H01F 27/025; H01F 27/2828

(57) ABSTRACT

A core includes an outer leg portion integrally provided at least at one end of a base portion, with an intermediate portion therebetween, and protruding from the intermediate portion substantially in parallel to an axis of a winding portion. An outer surface of the intermediate portion includes a rounded outer surface. A first outer boundary between an outer surface of the base portion and the rounded outer surface is at a location apart from an inner surface of the outer leg portion by a first predetermined distance measured perpendicularly to a plane containing the inner surface of the outer leg portion. A second outer boundary between an outer surface of the outer leg portion and the rounded outer surface is at a location apart from an inner surface of the base portion by a second predetermined distance measured perpendicularly to a plane containing the inner surface of the base portion.

### TECHNICAL FIELD

The present invention relates to a coil device that can be suitably used as, for example, a transformer.

### BACKGROUND

As shown in, for example, Patent Document 1 below, a coil device (e.g., a transformer) usually includes an E-shaped core. A conventional core (e.g., an E-shaped core) usually includes a sharp, substantially right-angled outer edge portion between an outer leg portion and a base portion. This right-angled portion may be rounded, but the rounded portion normally has a curvature of 0.2 to 0.3 mm.

Along with an increase in a current flowing in a wire constituting a coil, an increase in the temperature of the core has been a problem. As the temperature of the core increases, thermal stress on the core increases, which may cause damage to the core. In particular, for example, in a situation where heat is dissipated from part of the core using a heat-dissipating resin, the core may include a portion that is cooled by the heat-dissipating resin and a portion that is not cooled by the heat-dissipating resin. This may generate thermal stress at the core, possibly significantly reducing durability of the core.

Also in a situation where air cooling or the like is carried out without use of the heat-dissipating resin, excessive thermal stress may be generated at the core. In such a situation as well, durability of the core is reduced.
Patent Document 1: JP Patent Application Laid Open No. 2014-36194

### SUMMARY

The present invention has been achieved in view of such circumstances. It is an object of the invention to provide a coil device capable of having, for example, reduced thermal stress of a core.

To achieve the above object, a coil device according to one aspect of the present invention is a coil device including
a core including a magnetic body; and
a wire including a winding portion wound in a coil shape,
wherein
the core includes
a middle leg portion around which the winding portion of the wire is disposed,
a base portion magnetically coupled to one end of the middle leg portion and extending substantially perpendicularly to an axis of the winding portion, the base portion being in contact with or not in contact with the one end of the middle leg portion,
an intermediate portion, and
an outer leg portion integrally provided at least at one end of the base portion, with the intermediate portion in between the base portion and the outer leg portion, the outer leg portion protruding from the intermediate portion substantially in parallel to the axis of the winding portion;
an outer surface of the intermediate portion includes a rounded outer surface;
a first outer boundary between an outer surface of the base portion and the rounded outer surface is at a location apart from an inner surface of the outer leg portion by a first predetermined distance measured perpendicularly to a plane containing the inner surface of the outer leg portion; and
a second outer boundary between an outer surface of the outer leg portion and the rounded outer surface is at a location apart from an inner surface of the base portion by a second predetermined distance measured perpendicularly to a plane containing the inner surface of the base portion.

Experiments by the present inventors have revealed that, in a conventional core having a right-angled corner portion, heat generated due to a magnetic flux concentrated at an inner side of the corner portion between a base portion and an outer leg portion is not readily released outside, unable to be sufficiently dissipated. In the coil device according to the one aspect of the present invention, the outer surface of the intermediate portion between the base portion and the outer leg portion of the core is not a nearly right-angled corner portion but is the rounded outer surface.

Thus, the distance between an inner corner portion of the intermediate portion and the rounded outer surface of the intermediate portion is shorter than a conventional distance; and heat generated due to a magnetic flux concentrated at the inner corner portion of the intermediate portion is readily released to the rounded outer surface of the intermediate portion to improve heat-dissipation ability. Consequently, thermal stress of the core can be reduced. Also, inclusion of the rounded outer surface in the intermediate portion has an effect of reducing concentration of stress based on the shape of the intermediate portion. At the intermediate portion, the flow of a magnetic flux is smooth.

Preferably, an inner surface of the intermediate portion includes a rounded inner surface. Preferably, a first inner boundary between the inner surface of the base portion and the rounded inner surface is at a location apart from the inner surface of the outer leg portion by a third predetermined distance measured perpendicularly to the plane containing the inner surface of the outer leg portion. Preferably, a second inner boundary between the inner surface of the outer leg portion and the rounded inner surface is at a location apart from the inner surface of the base portion by a fourth predetermined distance measured perpendicularly to the plane containing the inner surface of the base portion. Such structures enable the inner surface of the intermediate portion between the base portion and the outer leg portion of the core to not be a nearly right-angled corner portion but to be the rounded inner surface, where the flow of a magnetic flux is smooth. Also, the distance between the rounded inner surface and the rounded outer surface stays substantially constant along the flow of the magnetic flux. This enables uniform heat dissipation from the rounded inner surface to the rounded outer surface, further improving heat-dissipation ability.

The third predetermined distance is preferably substantially the same as the first predetermined distance but may be different from the first predetermined distance. The fourth predetermined distance is preferably substantially the same as the second predetermined distance but may be different from the second predetermined distance. The distances being substantially the same enable the distance between the rounded inner surface and the rounded outer surface to readily stay substantially constant along the flow of a magnetic flux. This enables further uniform heat dissipation from the rounded inner surface to the rounded outer surface, further improving heat-dissipation ability.

The first predetermined distance is preferably substantially the same as the second predetermined distance but may be different from the second predetermined distance. The following relationships are preferably satisfied, where L1 denotes the first predetermined distance, L2 denotes the second predetermined distance, T1 denotes the thickness of the outer leg portion, T2 denotes the thickness of the base portion, the first predetermined distance is positive in a direction inward from the inner surface of the outer leg portion or negative in a direction outward from the inner surface of the outer leg portion, and the second predetermined distance is positive in a direction inward from the inner surface of the base portion or negative in a direction outward from the inner surface of the base portion.

L1/T1 is preferably within a range of −⅔ or more and ½ or less. L2/T2 is preferably within a range of −⅔ or more and ½ or less. L1/T1 is more preferably within a range of 0 or more and ½ or less or is still more preferably within a range of ¼ or more and ½ or less. L2/T2 is more preferably within a range of 0 or more and ½ or less or is still more preferably within a range of ¼ or more and ½ or less. Such ranges enable further improvement of heat-dissipation ability and further reduction of stress.

The third predetermined distance is preferably substantially the same as the fourth predetermined distance but may be different from the fourth predetermined distance.

The following relationships are preferably satisfied, where L3 denotes the third predetermined distance, L4 denotes the fourth predetermined distance, T1 denotes the thickness of the outer leg portion, T2 denotes the thickness of the base portion, the third predetermined distance is positive in a direction inward from the inner surface of the outer leg portion or negative in a direction outward from the inner surface of the outer leg portion, and the fourth predetermined distance is positive in a direction inward from the inner surface of the base portion or negative in a direction outward from the inner surface of the base portion.

L3/T1 is preferably within a range of −⅔ or more and ½ or less. L4/T2 is preferably within a range of −⅔ or more and ½ or less. L3/T1 is more preferably within a range of 0 or more and ½ or less or is still more preferably within a range of ¼ or more and ½ or less. L4/T2 is more preferably within a range of 0 or more and ½ or less or is still more preferably within a range of ¼ or more and ½ or less. Such ranges enable further improvement of heat-dissipation ability and further reduction of stress.

The outer leg portion is preferably at least partly immersed in a heat-dissipating resin; and the second outer boundary is located preferably below a venting surface of the heat-dissipating resin. In this situation, the rounded outer surface of the intermediate portion is at least partly directly immersed in the heat-dissipating resin. This further improves heat-dissipation ability.

The second outer boundary may be located between one end and an other end of the winding portion of the wire along the axis of the winding portion. In this situation, heat-dissipation ability can be improved while the coil device can be reduced in height.

The first outer boundary may be located between an outermost circumferential location and an innermost circumferential location of the winding portion of the wire. In this situation, heat-dissipation ability can be improved while the coil device can have a smaller size widthwise.

The second inner boundary may be located between the one end and the other end of the winding portion of the wire along the axis of the winding portion. In this situation, heat-dissipation ability can be improved while the coil device can be reduced in height.

The first inner boundary may be located between the outermost circumferential location and the innermost circumferential location of the winding portion of the wire. In this situation, heat-dissipation ability can be improved while the coil device can have a smaller size widthwise.

The rounded outer surface preferably includes a curved surface but may include a collection of at least one flat surface. Such a structure enables further improvement of heat-dissipation ability and further reduction of stress.

The rounded inner surface preferably includes a curved surface but may include a collection of at least one flat surface. Such a structure enables further improvement of heat-dissipation ability and further reduction of stress.

Preferably, a heat-dissipating plate is disposed outward from the rounded outer surface. Such a structure enables further improvement of heat-dissipation ability and further reduction of stress. The heat-dissipating plate may cover the outer surface of the base portion or may partly be immersed in the heat-dissipating resin.

### BRIEF DESCRIPTION OF THE DRAWING(S)

FIG. 1 is a schematic perspective view of a coil device according to one embodiment of the present invention.

FIG. 2A is an exploded perspective view of the coil device shown in FIG. 1.

FIG. 2B is an exploded perspective view of a modified example of the coil device shown in FIG. 2A.

FIG. 3 is a schematic sectional view of the coil device along a line III-III shown in FIG. 1.

FIG. 4A is a partially enlarged schematic diagram of details of an intermediate portion of a core shown in FIG. 3.

FIG. 4B is a partially enlarged schematic diagram, similar to FIG. 4A, of a relationship between a heat-dissipating plate and the intermediate portion of the core shown in FIG. 2A.

FIG. 5 is a schematic perspective view of a bobbin shown in FIG. 2A, showing a relationship between the bobbin and wires.

### DETAILED DESCRIPTION

Hereinafter, an embodiment is described.

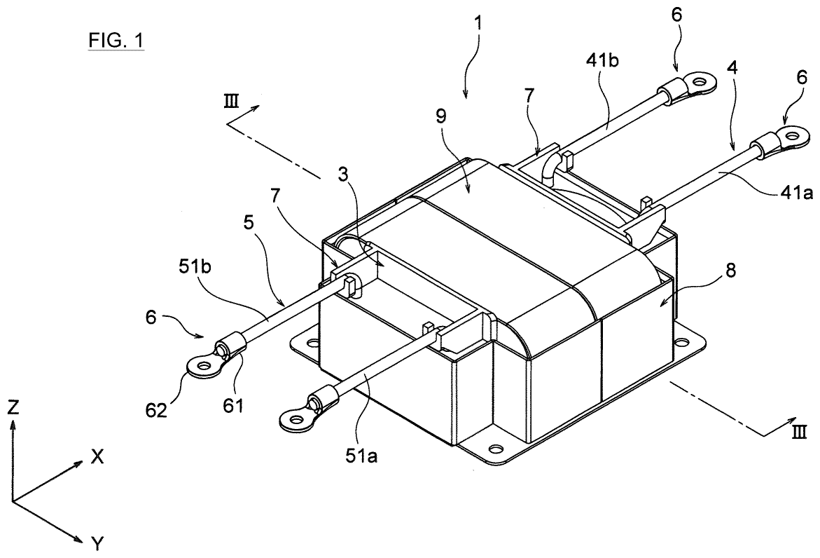

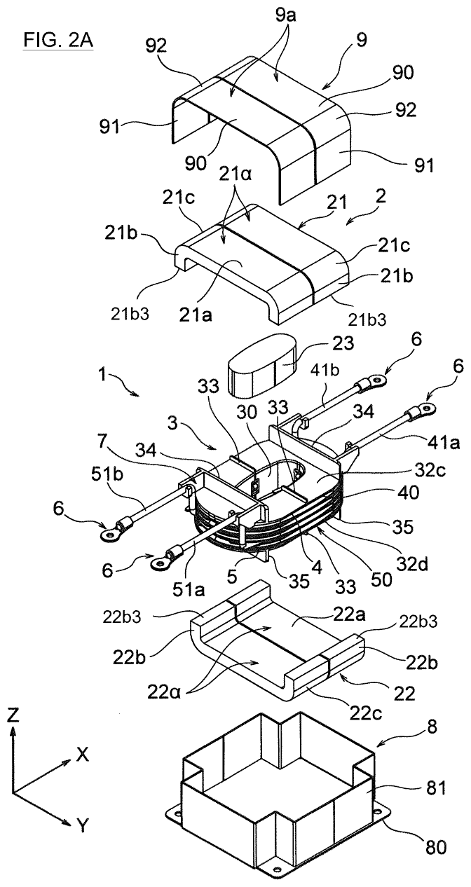

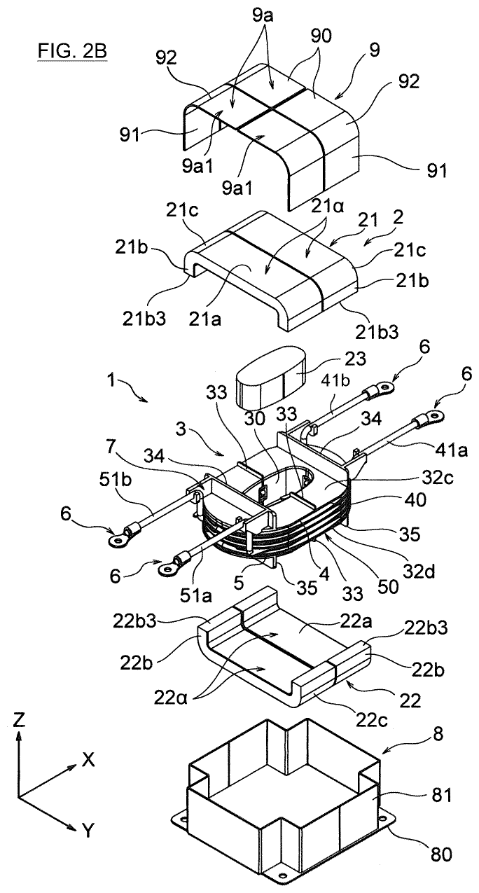

A coil device 1 according to an embodiment of the present invention shown in FIG. 1 functions as, for example, a leakage transformer and is included in an on-board charger, a power supply circuit of various electronic equipment, etc. As shown in FIG. 2A, the coil device 1 includes a core 2, a bobbin 3, and a case 8. In the drawings, the X-axis, the Y-axis, and the Z-axis are mutually perpendicular; and the Z-axis is parallel to the height orientation of the coil device 1 (winding axis direction of a coil). In the following description, with regard to the X-axis, the Y-axis, and the Z-axis, a direction toward a center of the coil device 1 is referred to as an inward direction, and a direction away from the center of the coil device 1 is referred to as an outward direction.

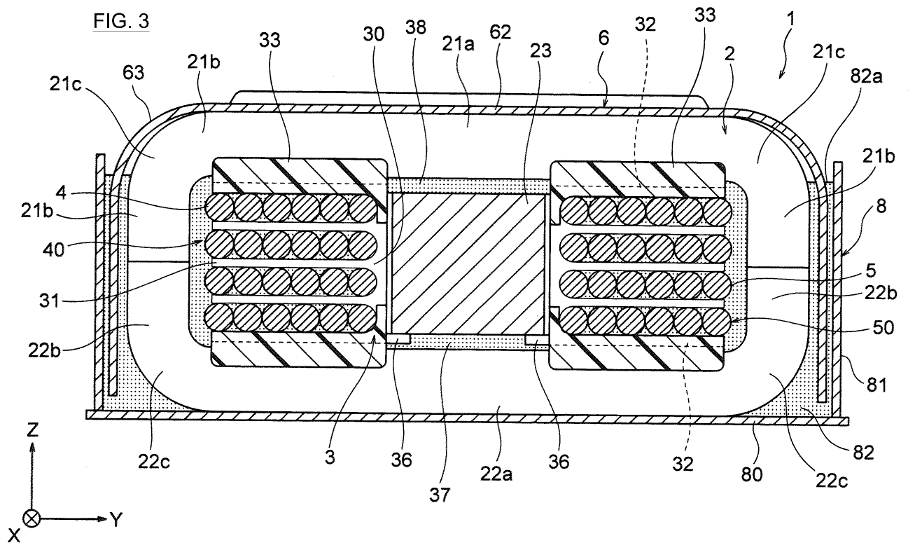

As shown in FIG. 3, a tubular portion 30 of the bobbin 3 is provided with, partway along the Z-axis, a main partitioning flange 31 for insulating a primary side coil against a secondary side coil so that the main partitioning flange 31 protrudes radially from an outer circumferential surface of the tubular portion 30. The tubular portion 30 is provided with, above the main partitioning flange 31 along the Z-axis, sub-partitioning flanges 32 at predetermined intervals along the Z-axis so that the sub-partitioning flanges 32 protrude radially from the outer circumferential surface of the tubular portion 30. In compartments between the main partitioning flange 31 and one of the sub-partitioning flanges 32 and between the sub-partitioning flanges 32, a first wire 4 is wound to form a first wire winding portion 40.

Similarly, the tubular portion 30 is provided with, below the main partitioning flange 31 along the Z-axis, sub-partitioning flanges 32 at predetermined intervals along the Z-axis so that the sub-partitioning flanges 32 protrude radially from the outer circumferential surface of the tubular portion 30. In compartments between the main partitioning flange 31 and one of the sub-partitioning flanges 32 and between the sub-partitioning flanges 32, a second wire 5 is wound to form a second wire winding portion 50.

The compartments between the main partitioning flange 31 and the sub-partitioning flanges 32 along the Z-axis and between the sub-partitioning flanges 32 have a size slightly larger than the outside diameter of the first wire 4 or the second wire 5. Only one row of the wire 4 or 5 can enter each of these compartments along the Z-axis. Thus, the wire 4 or 5 can be orderly wound around the outer circumferential surface of the tubular portion 30 of the bobbin 3.

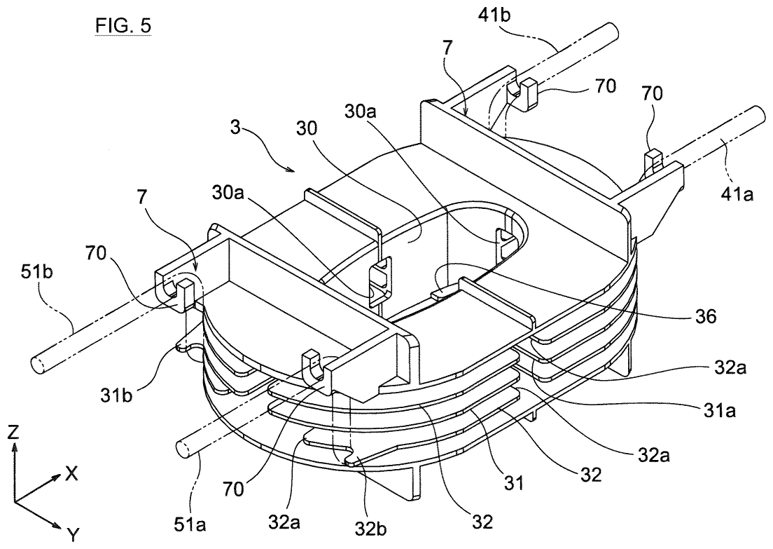

As shown in FIG. 5, the main partitioning flange 31 and the sub-partitioning flanges 32, which are located at both sides of the main partitioning flange 31 along the Z-axis, have notches 31a and 32a, respectively, at least at one point (four points in the embodiment) along the circumferential direction. The notches extend radially from circumferential points of the flanges 31 and 32 to circumferential points of the tubular portion 30. At respective locations corresponding to the notches 31a and 32a, the tubular portion 30 of the bobbin 3 has through-holes 30a, which penetrate the tubular portion 30. Through these through-holes 30a, a heat-dissipating resin 82 described later readily spreads inside and outside the tubular portion 30.

With regard to the notches 32a of the sub-partitioning flanges 32, the wire 4 or 5 shown in FIG. 3 can be moved through these notches 32a along the Z-axis between the adjacent compartments. This enables continuous winding of the wire 4 or 5. How the wire 4 or 5 is wound is not limited. The wires may be, for example, normally wound or a-wound.

Note that, while the second wire winding portion 50 is disposed below the first wire winding portion 40 along the Z-axis as shown in FIG. 3 in the present embodiment, they may be disposed vice versa. While, for example, the first wire winding portion 40 and the second wire winding portion 50 are the primary side coil and the secondary side coil of the transformer respectively in the present embodiment, they may be vice versa. The first wire winding portion 40 and the second wire winding portion 50 are separated by the main partitioning flange 31 in the Z-axis direction, and their coupling coefficient and the like are controlled.

In the present embodiment, conductive wires constitute the first wire 4 and the second wire 5. It may be that the wires are not insulation coated; however, the wires are preferably insulation coated. The conductive wires may be of any type and may be conductive core wires, such as round wires, rectangular wires, stranded wires, litz wires, and braided wires. The core wires may be covered with a fusing layer or an insulation layer, which may be made from any material, such as polyurethane, polyamide-imide, polyimide, and polyester.

In the present embodiment, self-fusing wires constitute the first wire 4 and the second wire 5; however, either of the wires may be a self-fusing wire, or both of the wires may constitute other wires. At least either the first wire winding portion 40 or the second wire winding portion 50 may be a flat coil. The first wire 4 and the second wire 5 may have the same diameter or different diameters. The diameters are not limited and are preferably, for example, within a range of 1.0 to 3.0 mm.

As shown in FIG. 2A, the first wire 4 constituting the first wire winding portion 40 includes lead portions 41a and 41b at both ends. The respective lead portions 41a and 41b are drawn upward along the Z-axis from the first wire winding portion 40 and are connected to terminals 6 and 6 shown in FIG. 1. The second wire 5 constituting the second wire winding portion 50 includes lead portions 51a and 51b at both ends. The respective lead portions 51a and 51b are drawn upward along the Z-axis from the second wire winding portion 50 and are connected to terminals 6 and 6.

As shown in FIG. 5, the respective lead portions 41a, 41b, 51a, and 51b are locked to lead locking portions 70 of lead attaching portions 7, which are located at both sides, along the X-axis, of the uppermost sub-partitioning flange 32 along the Z-axis of the bobbin 3. Note that, while the lead attaching portions 7 are integrally provided at the bobbin 3 in the present embodiment, the lead attaching portions 7 may be provided separately from the bobbin 3 and be coupled to the bobbin 3.

In the present embodiment, as shown in FIG. 5, the lead portion 51a is locked to a guide protrusion 32b of the sub-partitioning flange 32 disposed below the main partitioning flange 31 along the Z-axis and is then led upward along the Z-axis to be locked to the corresponding lead locking portion 70 of the lead attaching portion 7. The lead portion 51b is locked to a guide protrusion 31b of the main partitioning flange 31 and is then led upward along the Z-axis to be locked to the corresponding lead locking portion 70 of the lead attaching portion 7.

Although not shown in FIG. 5, the lead portion 41a is locked to a guide protrusion 32b of the sub-partitioning flange 32 disposed above the main partitioning flange 31 along the Z-axis and is then led upward along the Z-axis to be locked to the corresponding lead locking portion 70 of the lead attaching portion 7. The lead portion 41b is directly led upward along the Z-axis to be locked to the corresponding lead locking portion 70 of the lead attaching portion 7.

In the present embodiment, as shown in FIG. 1, each of the terminals 6 includes a wire connection portion 61 and an external connection portion 62. While the terminals 6 are apart from the lead attaching portions 7 in the present embodiment, the terminals 6 may be attached to the lead attaching portions 7. The structure of the terminals 6 is not limited to the example shown in the drawings. The terminals 6 may be plug-in terminals or terminals with other structures. Each terminal 6, which includes the wire connection portion 61 and the external connection portion 62, is formed by, for example, pressing one metal plate.

As shown in FIG. 2A, in the present embodiment, the core 2 can be disassembled into a first core 21, a second core 22, and a middle leg portion 23. The first core 21 is disposed above the second core 22 along the Z-axis. The second core 22 is disposed below the first core 21 along the Z-axis. The middle leg portion 23 is disposed between the first core 21 and the second core 22. The first core 21 is divided into two first core divisions 21α and 21α along the X-axis. Similarly, the second core 22 is divided into two second core divisions 22α and 22α along the X-axis.

Each of the first core divisions 21α includes a first base portion 21a having a flat shape and outer leg portions 21b and 21b protruding downward along the Z-axis from both sides of the first base portion 21a in the Y-axis direction. Each of the second core divisions 22α includes a second base portion 22a having a flat shape and outer leg portions 22b and 22b protruding upward along the Z-axis from both sides of the second base portion 22a in the Y-axis direction.

In the present embodiment, the first core divisions 21α and the second core divisions 22α are each a U-shaped core substantially having a U-shape in a section parallel to a plane containing the Z-axis and the Y-axis. The first core divisions 21α and the second core divisions 22α have the same shape but may have different shapes. For example, either the first core divisions 21α or the second core divisions 22α may be U-shaped cores, and the other cores may be I-shaped cores.

The first base portion 21a of each first core division 21α is attached to an outer surface of the sub-partitioning flange 32 at an upper end of the tubular portion 30 of the bobbin 3. The outer surface (upper surface 32c) of the sub-partitioning flange 32 at the upper end of the tubular portion 30 is provided with positioning projections 33, which can provide a space between the adjacent first base portions 21a and 21a. With such a space, improvement of heat-dissipation ability can be expected.

The second base portion 22a of each second core division 22α is attached to an outer surface of the sub-partitioning flange 32 at a lower end of the tubular portion 30 of the bobbin 3. The outer surface (lower surface 32d) of the sub-partitioning flange 32 at the lower end of the tubular portion 30 is provided with positioning projections 33, which can provide a space between the adjacent second base portions 22a and 22a. With such a space, improvement of heat-dissipation ability can be expected.

As shown in FIG. 2A, core guide walls 34 are provided at both sides in the X-axis direction of the sub-partitioning flange 32 at the upper end of the tubular portion 30 of the bobbin 3 along the Z-axis. The middle leg portion 23 is inserted from above in the Z-axis direction into a middle-leg hole defined by an inner circumferential surface of the tubular portion 30 of the bobbin 3.

Then, against the outer surface (upper surface 32c) of the sub-partitioning flange 32 between the core guide walls 34, the first base portions 21a of the first core divisions 21α are placed. The outer leg portions 21b of the first core 21 cover an upper portion, along the Z-axis, of the bobbin 3 at both sides in the Y-axis direction.

Core guide walls 35 are provided at both sides in the X-axis direction of the sub-partitioning flange 32 at the lower end of the tubular portion 30 of the bobbin 3 along the Z-axis. Against the outer surface (lower surface 32d) of the sub-partitioning flange 32 between the core guide walls 35, the second base portions 22a of the second core divisions 22α are placed. The outer leg portions 22b of the second core 22 cover a lower portion, along the Z-axis, of the bobbin 3 at both sides in the Y-axis direction. Extremities 22b3 of the outer leg portions 22b abut extremities 21b3 of the outer leg portions 21b of the first core 21. As necessary, they are joined using an adhesive.

As shown in FIGS. 3 and 5, at an inner circumferential surface of the sub-partitioning flange 32 at the lower end of the tubular portion 30 of the bobbin 3 along the Z-axis, inner protrusions 36 protruding inward from the inner circumferential surface of the tubular portion 30 are provided along its circumferential direction. The inner protrusions 36 protrude from the inner circumferential surface of the tubular portion 30 to the extent that the inner protrusions 36 do not cover a lower end of the middle-leg hole defined by the inner circumferential surface of the tubular portion 30 along the Z-axis. As shown in FIG. 3, the inner protrusions 36 abut an outer circumferential portion of a lower end of the middle leg portion 23 along the Z-axis. Consequently, a space 37 can be provided between the lower end of the middle leg portion 23 along the Z-axis and the second base portions 22a of the second core 22. The heat-dissipating resin 82 enters the space 37. The length of the space 37 can be controlled by changing the design thickness of the inner protrusions 36 along the Z-axis.

Controlling the length of the middle leg portion 23 along the Z-axis to be smaller by a predetermined length than the height of the tubular portion 30 along the Z-axis (from the inner protrusions 36 to the upper surface 32c of the uppermost sub-partitioning flange 32) can provide a space 38 between an upper end of the middle leg portion 23 along the Z-axis and the first base portions 21a of the first core 21.

In the present embodiment, the space 38 is filled with the heat-dissipating resin 82 as shown in FIG. 3; however, in other embodiments, coil devices may be structured so that the heat-dissipating resin 82 does not enter at least a part of the space 38 and that the middle leg portion 23 is sufficiently cooled. Specifically, the location of a venting surface 82a of the heat-dissipating resin 82, with which the case 8 is filled, can be determined in relation to the volume or the like of the middle leg portion 23.

The location of the venting surface 82a may be determined so that, for example, 70% or more, preferably 80% or more, more preferably 90% or more, or still more preferably 95% or more of the volume of the middle leg portion 23 is located below the venting surface 82a of the heat-dissipating resin 82 and below lower surfaces of the first base portions 21a along the Z-axis. Such a structure provides the space 38 with an air layer, where the heat-dissipating resin 82 does not enter.

The location of the venting surface 82a of the heat-dissipating resin 82 is determined so that the second wire winding portion 50 of the second wire 5 is sufficiently immersed in the heat-dissipating resin 82 and that preferably 80% or more, more preferably 95% or more, or substantially 100% or more of the first wire winding portion 40 of the first wire 4 is immersed in the heat-dissipating resin 82. With such a structure, heat generated at the winding portion 40 or 50 of the wire 4 or 5 is cooled by the heat-dissipating resin 82.

In the present embodiment, heat transferred from the winding portion 40 or 50 of the wire 4 or 5 or the core 2 to the heat-dissipating resin 82 is dissipated, via the case 8, to a cooling member (e.g., a cooling block having a cooling passage) placed under a lower surface of a bottom plate 80 of the case 8. Note that the venting surface 82a is a solidified liquid surface of the heat-dissipating resin 82 in a fluid state entering the case 8.

In the present embodiment, the cores 21 and 22 and the middle leg portion 23 may be any cores containing a magnetic body and may be made from, for example, ferrites, metal magnetic bodies, or resin containing a magnetic powder.

As shown in FIG. 3, the case 8 includes the bottom plate 80 having a substantially rectangular shape and a side plate 81 extending upward along the Z-axis from four sides of the bottom plate 80 to provide a bottomed accommodation space. The top of the case 8 along the Z-axis is open. The case 8 is preferably made from metal with high thermal conductivity (e.g., aluminum) but may be made from resin.

The heat-dissipating resin 82 is also referred to as potting resin and is made from, for example, silicone resin, urethane resin, or epoxy resin, which remain soft after injection. The potting resin has a modulus of longitudinal elasticity of preferably 0.1 to 100 MPa. In the present embodiment, heat generated at the first wire winding portion 40, the second wire winding portion 50, and the core 2 is efficiently dissipated outside from the bottom of the case 8 via, for example, the heat-dissipating resin 82 and the case 8 to enable an increase in cooling efficiency of the coil device 1.

The bobbin 3 (with the wires) having the core 2 shown in FIG. 2A attached may be accommodated in the case 8 after the case 8 is filled with the heat-dissipating resin 82 in advance; or the case 8 may be filled with the heat-dissipating resin 82 after the bobbin 3 (with the wires) having the core 2 attached is accommodated in the case 8.

In the present embodiment, as shown in FIG. 3, the core 2 includes the middle leg portion 23, around which the winding portions 40 and 50 of the wires 4 and 5 are disposed, and the base portions 21a and 22a, which are, in contact with or not in contact with respective ends of the middle leg portion 23 along the Z-axis, magnetically coupled to the ends and extend substantially perpendicularly (e.g., in the Y-axis direction) to the axes (Z-axis) of the winding portions 40 and 50. The core 2 also includes the outer leg portions 21b and 22b, which are integrally provided at least at one end of the base portions 21a and 22a, with intermediate portions 21c and 22c in between the base portions and the outer leg portions, and protrude from the intermediate portions 21c and 22c substantially in parallel to the Z-axis.

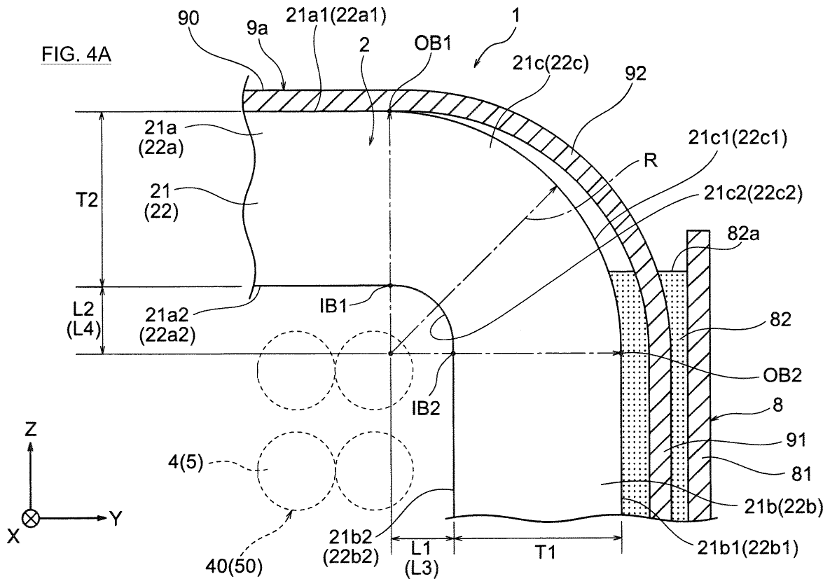

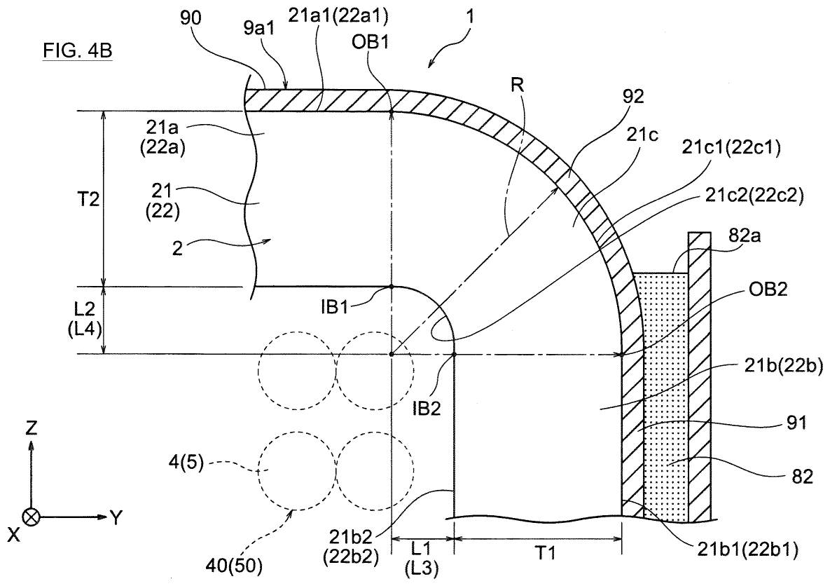

In the present embodiment, as shown in FIG. 4A, each intermediate portion 21c of the first core 21 is defined as a portion that integrally couples the first base portion 21a and the outer leg portion 21b. An outer surface of the intermediate portion 21c constitutes a rounded outer surface 21c1. The rounded outer surface 21c1 is in an arc and has a radius of curvature R. While the rounded outer surface 21c1 constitutes a curved surface in the present embodiment, the rounded outer surface 21c1 may constitute not only the curved surface but also a single flat surface or a collection of flat surfaces. The same applies to a rounded inner surface 21c2, which is described later.

An outer surface 21a1 and an inner surface 21a2 of the first base portion 21a are preferably flat surfaces parallel to a plane containing the X-axis and the Y-axis but may have slight irregularities or may partly include curved surfaces. An outer surface 21b1 and an inner surface 21b2 of the outer leg portion 21b are preferably flat surfaces parallel to a plane containing the X-axis and the Z-axis but may have slight irregularities or may partly include curved surfaces.

In the present embodiment, a first outer boundary OB1 between the outer surface 21a1 of the first base portion 21a and the rounded outer surface 21c1 is at a location apart from the inner surface 21b2 of the outer leg portion 21b by a first predetermined distance L1 measured perpendicularly to a plane containing the inner surface 21b2. A second outer boundary OB2 between the outer surface 21b1 of the outer leg portion 21b and the rounded outer surface 21c1 is at a location apart from the inner surface 21a2 of the first base portion 21a by a second predetermined distance L2 measured perpendicularly to a plane containing the inner surface 21a2.

In the present embodiment, as shown in FIG. 2A, the second core 22 has a structure similar to that of the first core 21. The intermediate portions 22c of the second core 22 are similar to the intermediate portions 21c of the first core 21. That is, as shown in FIG. 4A, each intermediate portion 22c is defined as a portion that integrally couples the second base portion 22a and the outer leg portion 22b. An outer surface of the intermediate portion 22c constitutes a rounded outer surface 22c1. The rounded outer surface 22c1 is in an arc and has a radius of curvature R. While the rounded outer surface 22c1 constitutes a curved surface in the present embodiment, the rounded outer surface 22c1 may constitute not only the curved surface but also a single flat surface or a collection of flat surfaces.

An outer surface 22a1 and an inner surface 22a2 of the second base portion 22a are preferably flat surfaces parallel to a plane containing the X-axis and the Y-axis but may have slight irregularities or may partly include curved surfaces. An outer surface 22b1 and an inner surface 22b2 of the outer leg portion 22b are preferably flat surfaces parallel to a plane containing the X-axis and the Z-axis but may have slight irregularities or may partly include curved surfaces.

In the present embodiment, a first outer boundary OB1 between the outer surface 22a1 of the second base portion 22a and the rounded outer surface 22c1 is at a location apart from the inner surface 22b2 of the outer leg portion 22b by the first predetermined distance L1 measured perpendicularly to a plane containing the inner surface 22b2. A second outer boundary OB2 between the outer surface 22b1 of the outer leg portion 22b and the rounded outer surface 22c1 is at a location apart from the inner surface 22a2 of the second base portion 22a by the second predetermined distance L2 measured perpendicularly to a plane containing the inner surface 22a2.

Experiments by the present inventors have revealed that, in a conventional core having a right-angled corner portion (including a rounded portion with an R of less than 0.5 mm), heat generated due to a magnetic flux concentrated at an inner side of the corner portion is not readily released outside, unable to be sufficiently dissipated. In the coil device 1 according to the present embodiment, the outer surface 21c1 (22c1) of the intermediate portion 21c (22c) between the base portion 21a (22a) and the outer leg portion 21b (22b) of the core 2 is not a nearly right-angled corner portion (including a rounded portion with an R of 0.5 mm or less) but is the rounded outer surface 21c1 (22c1) with an R of preferably 1 mm or more or more preferably 2 mm or more.

Thus, the distance between the rounded inner surface 21c2 (22c2) and the rounded outer surface 21c1 (22c1) of the intermediate portion 21c (22c) is shorter than a conventional distance; and heat generated due to a magnetic flux concentrated at the corner portion is readily released to the rounded outer surface 21c1 (22c1) of the intermediate portion 21c (22c) to improve heat-dissipation ability. Consequently, thermal stress of the core 2 can be reduced. Also, inclusion of the rounded outer surface 21c1 (22c1) in the intermediate portion 21c (22c) has an effect of reducing concentration of stress based on the shape of the intermediate portion 21c (22c). At the intermediate portion 21c (22c), the flow of a magnetic flux is smooth.

In the present embodiment, the rounded inner surface 21c2 (22c2) constitutes the inner surface of the intermediate portion 21c (22c). Preferably, a first inner boundary IB1 between the inner surface 21a2 (22a2) of the base portion 21a (22a) and the rounded inner surface 21c2 (22c2) is at a location apart from the inner surface 21b2 (22b2) of the outer leg portion 21b (22b) by a third predetermined distance L3 measured perpendicularly to the plane containing the inner surface 21b2 (22b2). Preferably, a second inner boundary IB2 between the inner surface 21b2 (22b2) of the outer leg portion 21b (22b) and the rounded inner surface 21c2 (22c2) is at a location apart from the inner surface 21a2 (22a2) of the base portion 21a (22a) by a fourth predetermined distance L4 measured perpendicularly to the plane containing the inner surface 21a2 (22a2).

Such structures enable the inner surface of the intermediate portion 21c (22c) between the base portion 21a (22a) and the outer leg portion 21b (22b) of the core 2 to not be a nearly right-angled corner portion but to be the rounded inner surface 21c2 (22c2), where the flow of a magnetic flux is smooth. Also, the distance between the rounded inner surface 21c2 (22c2) and the rounded outer surface 21c1 (22c1) stays substantially constant along the flow of the magnetic flux. This enables uniform heat dissipation from the rounded inner surface 21c2 (22c2) to the rounded outer surface 21c1 (22c1), further improving heat-dissipation ability.

The third predetermined distance L3 is preferably substantially the same as the first predetermined distance L1 but may be different from the first predetermined distance L1. The fourth predetermined distance L4 is preferably substantially the same as the second predetermined distance L2 but may be different from the second predetermined distance L2. The distances being substantially the same enable the distance between the rounded inner surface 21c2 (22c2) and the rounded outer surface 21c1 (22c1) to readily stay substantially constant along the flow of a magnetic flux. This enables further uniform heat dissipation from the rounded inner surface 21c2 (22c2) to the rounded outer surface 21c1 (22c1), further improving heat-dissipation ability.

The first predetermined distance L1 is preferably substantially the same as the second predetermined distance L2 but may be different from the second predetermined distance L2. The following relationships are preferably satisfied, where L1 denotes the first predetermined distance; L2 denotes the second predetermined distance; T1 denotes the thickness of the outer leg portion; T2 denotes the thickness of the base portion; the first predetermined distance L1 is positive in a direction inward from the inner surface 21b2 (22b2) of the outer leg portion 21b (22b) or negative in a direction outward from the inner surface 21b2 (22b2) of the outer leg portion 21b (22b); and the second predetermined distance L2 is positive in a direction inward from the inner surface 21a2 (22a2) of the base portion 21a (22a) or negative in a direction outward from the inner surface 21a2 (22a2) of the base portion 21a (22a).

L1/T1 is preferably within a range of −⅔ or more and ½ or less. L2/T2 is also preferably within a range of −⅔ or more and ½ or less. L1/T1 is more preferably within a range of 0 or more and ½ or less or is still more preferably within a range of ¼ or more and ½ or less. L2/T2 is more preferably within a range of 0 or more and ½ or less or is still more preferably within a range of ¼ or more and ½ or less. Such ranges enable further improvement of heat-dissipation ability and further reduction of stress. Note that, if L1/T1 or L2/T2 is too large, the coil device 1 tends to have a larger size or the space for the winding portion 40 (50) of the wire disposed inward from the base portion 21a (22a) and the outer leg portion 21b (22b) tends to be narrower.

The third predetermined distance L3 is preferably substantially the same as the fourth predetermined distance L4 but may be different from the fourth predetermined distance L4. The following relationships are preferably satisfied, where L3 denotes the third predetermined distance; L4 denotes the fourth predetermined distance; T1 denotes the thickness of the outer leg portion 21b (22b); T2 denotes the thickness of the base portion 21a (22a); the third predetermined distance L3 is positive in a direction inward from the inner surface 21b2 (22b2) of the outer leg portion 21b (22b) or negative in a direction outward from the inner surface 21b2 (22b2) of the outer leg portion 21b (22b); and the fourth predetermined distance L4 is positive in a direction inward from the inner surface 21a2 (22a2) of the base portion 21a (22a) or negative in a direction outward from the inner surface 21a2 (22a2) of the base portion 21a (22a).

L3/T1 is preferably within a range of −⅔ or more and ½ or less. L4/T2 is also preferably within a range of −⅔ or more and ½ or less. L3/T1 is more preferably within a range of 0 or more and ½ or less or is still more preferably within a range of ¼ or more and ½ or less. L4/T2 is more preferably within a range of 0 or more and ½ or less or is still more preferably within a range of ¼ or more and ½ or less. Such ranges enable further improvement of heat-dissipation ability and further reduction of stress. Note that, if L3/T1 or L4/T2 is too large, the coil device 1 tends to have a large sizer or the space for the winding portion 40 (50) of the wire disposed inward from the base portion 21a (22a) and the outer leg portion 21b (22b) tends to be narrower.

Note that, in the present embodiment, the boundary OB1, OB2, IB1, or IB2 can be defined as, for example, a boundary between the curved surface (which may be a single flat surface or a collection of flat surfaces) of the intermediate portion 21c (22c) and a plane constituting at least a part of the outer surface or the inner surface of the base portion or the outer leg portion and containing the X-axis and the Y-axis or containing the X-axis and the Z-axis.

As shown in FIG. 4A, the outer leg portion 21b (22b) is preferably at least partly immersed in the heat-dissipating resin 82, and the second outer boundary OB2 is located preferably below the venting surface 82a of the heat-dissipating resin 82. In this situation, the rounded outer surface 21c1 (22c1) of the intermediate portion 21c (22c) is at least partly directly immersed in the heat-dissipating resin 82. This further improves heat-dissipation ability.

Note that, while the venting surface 82a is located above the inner surface 21a2 of the first base portion 21a of the first core 21 to cover the winding portion 40 (50) and the core 2 below a lower part of the first base portion 21a with the heat-dissipating resin 82 in the example of FIG. 4A, the present embodiment is not limited to that.

The venting surface 82a may be, for example, substantially flush with the inner surface 21a2 of the first base portion 21a or located below the inner surface 21a2 along the Z-axis. The venting surface 82a is preferably above an upper end of the winding portion 40 (50) along the Z-axis but may be flush with or below the upper end. The location of the venting surface 82a may be determined in relation to the location of the upper end of the middle leg portion 23 shown in FIG. 2A. The upper end of the middle leg portion 23 may be located, for example, above the venting surface 82a of the heat-dissipating resin 82. In this situation, a gap between the middle leg portion 23 and the first base portion 21a can have an air layer. The upper end of the middle leg portion 23 may be flush with the venting surface 82a of the heat-dissipating resin 82 or may be located below the venting surface 82a.

In the present embodiment, the second outer boundary OB2 is located preferably between one end and an other end of the winding portion 40 (50) of the wire 4 (5) along the axis (substantially parallel to the Z-axis) of the winding portion 40 (50). In this situation, heat-dissipation ability can be improved while the coil device 1 can be reduced in height.

In the present embodiment, the first outer boundary OB1 is located preferably between an outermost circumferential location and an innermost circumferential location of the winding portion 40 (50) of the wire 4 (5). In this situation, heat-dissipation ability can be improved while the coil device 1 can have a smaller size widthwise along the Y-axis.

The second inner boundary IB2 is located preferably between the one end and the other end of the winding portion 40 (50) of the wire 4 (5) along the Z-axis. In this situation, heat-dissipation ability can be improved while the coil device 1 can be reduced in height.

The first inner boundary IB1 is located preferably between the outermost circumferential location and the innermost circumferential location of the winding portion 40 (50) of the wire 4 (5). In this situation, heat-dissipation ability can be improved while the coil device 1 can have a smaller size widthwise along the Y-axis.

As shown in FIG. 2A, intermediate portions 92 of a heat-dissipating plate 9 are preferably disposed outward from the rounded outer surfaces 21c1 of the first core 21 at an upper side along the Z-axis. Corresponding to the first core divisions 21α of the first core 21, a pair of heat-dissipating plate divisions 9a constitutes the heat-dissipating plate 9 as shown in FIG. 2A. However, a single heat-dissipating plate may constitute the heat-dissipating plate 9. Each of the heat-dissipating plate divisions 9a includes a top portion 90, a side portion 91, and the intermediate portions 92. The heat-dissipating plate 9 can be formed by bending or folding a plate member (e.g., a metal plate member) with excellent thermal conductivity.

As shown in FIG. 4A, the top portion 90 adheres to the outer surface 21a1 of the first base portion 21a of the first core 21 to absorb heat; the intermediate portion 92 is disposed in contact with or not in contact with the rounded outer surface 21c1 of the intermediate portion 21c of the first core 21; the side portion 91 is disposed in contact with or not in contact with the outer surface 21b1 of the outer leg portion 21b; and at least a lower end of the side portion 91 along the Z-axis is immersed in the heat-dissipating resin 82. This releases heat of the first core 21 to the heat-dissipating resin 82. Such structures enable further improvement of heat-dissipation ability of the coil device 1 and further reduction of stress.

To certainly enable the intermediate portion 92 and the side portion 91 of the heat-dissipating plate 9 to be in contact with the rounded outer surface 21c1 of the intermediate portion 21c and the outer surface 21b1 of the outer leg portion 21b of the first core 21 respectively as shown in FIG. 4B, each of the heat-dissipating plate divisions 9a is divided into two along the Y-axis to provide a pair of heat-dissipating plate subdivisions 9a1 as shown in, for example, FIG. 2B. Because each of the heat-dissipating plate subdivisions 9a1 includes a single intermediate portion 92 and a single side portion 91, it becomes easy to certainly enable the intermediate portion 92 of the heat-dissipating plate 9 to be in contact with the rounded outer surface 21c1 of the intermediate portion 21c of the first core 21 and the side portion 91 of the heat-dissipating plate 9 to be in contact with the outer surface 21b1 of the outer leg portion 21b.

The present invention is not limited to the above embodiment and can be variously modified within the scope of the present invention.

In the above embodiment, for example, the tubular portion 30 of the bobbin 3 is disposed between the middle leg portion 23 and the winding portions 40 and 50 of the wires 4 and 5; however, the winding portions 40 and 50 (e.g., air core coils) of the wires 4 and 5 may be disposed around the middle leg portion 23 without the bobbin 3 being disposed there.

In the above embodiment, the coil device 1 includes the lead attaching portions 7, which hold the lead portions 41a, 41b, 51a, and 51b of the wires 4 and 5, integrally with the bobbin 3; however, the lead attaching portions 7 and the bobbin 3 may be separate members. In the above embodiment, the terminals 6 are not attached to the lead attaching portions 7; however, the terminals 6 may be attached to terminal blocks, which may be attached to the lead attaching portions 7. In that situation, the terminal blocks may double as the lead attaching portions 7.

A pair of terminal blocks may be disposed opposite each other along the X-axis of the coil device 1. Alternatively, one of the terminal blocks may be disposed at one side of the coil device 1 along the X-axis while the other terminal block may be disposed at one side of the coil device 1 along the Y-axis. Also, the terminal blocks may be integrally provided at the bobbin 3, may be provided as separate members from the bobbin 3, or may be attached to the bobbin or the case 8.

### REFERENCE NUMERALS

1 . . . coil device
2 . . . core
21 . . . first core
21α . . . first core division
21a . . . first base portion
21a1 . . . outer surface
21a2 . . . inner surface
21b . . . outer leg portion
21b1 . . . outer surface
21b2 . . . inner surface
21b3 . . . extremity
21c . . . intermediate portion
21c1 . . . rounded outer surface
21c2 . . . rounded inner surface
22 . . . second core
22α . . . second core division
22a . . . second base portion
22a1 . . . outer surface
22a2 . . . inner surface
22b . . . outer leg portion
22b1 . . . outer surface
22b2 . . . inner surface
22b3 . . . extremity
22c . . . intermediate portion
22c1 . . . rounded outer surface
22c2 . . . rounded inner surface
23 . . . middle leg portion
3 . . . bobbin
30 . . . tubular portion
30a . . . through-hole
31 . . . main partitioning flange
31a . . . notch
31b . . . guide protrusion
32 . . . sub-partitioning flange
32a . . . notch
32b . . . guide protrusion
32c . . . upper surface
32d . . . lower surface
33 . . . positioning projection
34, 35 . . . core guide wall
36 . . . inner protrusion
37, 38 . . . space
4 . . . first wire
40 . . . first wire winding portion
41a, 41b . . . lead portion
5 . . . second wire
50 . . . second wire winding portion
51a, 51b . . . lead portion
6 . . . terminal
61 . . . wire connection portion
62 . . . external connection portion
7 . . . lead attaching portion
70 . . . lead locking portion
8 . . . case
80 . . . bottom plate
81 . . . side plate
82 . . . heat-dissipating resin
82a . . . venting surface
9 . . . heat-dissipating plate
9a . . . heat-dissipating plate division
9a1 . . . heat-dissipating plate subdivision
90 . . . top portion
91 . . . side portion
92 . . . intermediate portion
OB1 . . . first outer boundary
OB2 . . . second outer boundary
IB1 . . . first inner boundary
IB2 . . . second inner boundary

What is claimed is:

1. A coil device comprising:
a core comprising a magnetic body; and
a wire comprising a winding portion wound in a coil shape,
wherein
the core comprises
a middle leg portion around which the winding portion of the wire is disposed,
a base portion magnetically coupled to one end of the middle leg portion and extending substantially perpendicularly to an axis of the winding portion, the base portion being in contact with or not in contact with the one end of the middle leg portion,
an intermediate portion, and
an outer leg portion integrally provided at least at one end of the base portion, with the intermediate portion in between the base portion and the outer leg portion, the outer leg portion protruding from the intermediate portion substantially in parallel to the axis of the winding portion;
an outer surface of the intermediate portion comprises a rounded outer surface;
a first outer boundary between an outer surface of the base portion and the rounded outer surface is at a location apart from an inner surface of the outer leg portion by a first predetermined distance measured perpendicularly to a plane containing the inner surface of the outer leg portion; and
a second outer boundary between an outer surface of the outer leg portion and the rounded outer surface is at a location apart from an inner surface of the base portion by a second predetermined distance measured perpendicularly to a plane containing the inner surface of the base portion.

2. The coil device according to claim 1, wherein
an inner surface of the intermediate portion comprises a rounded inner surface;
a first inner boundary between the inner surface of the base portion and the rounded inner surface is at a location apart from the inner surface of the outer leg portion by a third predetermined distance measured perpendicularly to the plane containing the inner surface of the outer leg portion; and
a second inner boundary between the inner surface of the outer leg portion and the rounded inner surface is at a location apart from the inner surface of the base portion by a fourth predetermined distance measured perpendicularly to the plane containing the inner surface of the base portion.

3. The coil device according to claim 2, wherein
the third predetermined distance is substantially the same as or different from the first predetermined distance; and
the fourth predetermined distance is substantially the same as or different from the second predetermined distance.

4. The coil device according to claim 1, wherein
the first predetermined distance is substantially the same as or different from the second predetermined distance;
L1/T1 is within a range of −⅔ or more and ½ or less; and
L2/T2 is within a range of −⅔ or more and ½ or less,
where
L1 denotes the first predetermined distance,
L2 denotes the second predetermined distance,
T1 denotes a thickness of the outer leg portion,
T2 denotes a thickness of the base portion,
the first predetermined distance is positive in a direction inward from the inner surface of the outer leg portion or negative in a direction outward from the inner surface of the outer leg portion, and
the second predetermined distance is positive in a direction inward from the inner surface of the base portion or negative in a direction outward from the inner surface of the base portion.

5. The coil device according to claim 4, wherein
L1/T1 is within a range of 0 or more and ½ or less; and
L2/T2 is within a range of 0 or more and ½ or less.

6. The coil device according to claim 2, wherein
the third predetermined distance is substantially the same as or different from the fourth predetermined distance;
L3/T1 is within a range of −⅔ or more and ½ or less; and
L4/T2 is within a range of −⅔ or more and ½ or less,
where
L3 denotes the third predetermined distance,
L4 denotes the fourth predetermined distance,
T1 denotes a thickness of the outer leg portion,
T2 denotes a thickness of the base portion,
the third predetermined distance is positive in a direction inward from the inner surface of the outer leg portion or negative in a direction outward from the inner surface of the outer leg portion, and
the fourth predetermined distance is positive in a direction inward from the inner surface of the base portion or negative in a direction outward from the inner surface of the base portion.

7. The coil device according to claim 6, wherein
L3/T1 is within a range of 0 or more and ½ or less; and
L4/T2 is within a range of 0 or more and ½ or less.

8. The coil device according to claim 1, wherein
the outer leg portion is at least partly immersed in a heat-dissipating resin; and
the second outer boundary is located below a venting surface of the heat-dissipating resin.

9. The coil device according to claim 1, wherein the second outer boundary is located between one end and an other end of the winding portion of the wire along the axis of the winding portion.

10. The coil device according to claim 1, wherein the first outer boundary is located between an outermost circumferential location and an innermost circumferential location of the winding portion of the wire.

11. The coil device according to claim 2, wherein the second inner boundary is located between one end and an other end of the winding portion of the wire along the axis of the winding portion.

12. The coil device according to claim 2, wherein the first inner boundary is located between an outermost circumferential location and an innermost circumferential location of the winding portion of the wire.

13. The coil device according to claim 1, wherein the rounded outer surface comprises a curved surface or a collection of at least one flat surface.

14. The coil device according to claim 2, wherein the rounded inner surface comprises a curved surface or a collection of at least one flat surface.

15. The coil device according to claim 1, wherein a heat-dissipating plate is disposed outward from the rounded outer surface.
